(19) United States
(12) Patent Application Publication
(10) Pub. No.: US 2015/0140912 A1
(43) Pub. Date: May 21, 2015

(54) COIN HOPPER WITH A COIN-DELIVERING PRESSER

(71) Applicant: INTERNATIONAL CURRENCY TECHNOLOGIES CORPORATION, Taipei (TW)

(72) Inventors: Tien-Yuan CHIEN, Taipei (TW); Dong-Ying YANG, Taipei (TW); Chia-Hung HU, Taipei (TW)

(73) Assignee: INTERNATIONAL CURRENCY TECHNOLOGIES CORPORATION, Taipei (TW)

(21) Appl. No.: 14/086,359

(22) Filed: Nov. 21, 2013

(51) Int. Cl. G07D 1/00

(52) U.S. Cl. CPC G07D 1/00
USPC 453/57

(57) ABSTRACT

A coin hopper includes a coin-dispensing unit including a hopper defining a coin outlet, a rotating disk, a power drive, a sensor module and a circuit module for dispensing coins having different thicknesses, and a coin-delivering presser mounted in the hopper and including an elastic member and a float rotatably supported on the elastic member for pressing on one thick coin or thin coin in the rotating disk, enabling the coins to be individually and smoothly delivered to the coin outlet for dispensing and avoiding a coin stuck problem.

### BACKGROUND OF THE INVENTION

1. Field of the Invention

The present invention relates to coin dispensing technology and more particularly, to a coin hopper, which uses a spring-loaded float to adjust a coin-delivery gap, enabling coins having different thicknesses to be individually and smoothly delivered to a coin outlet for dispensing and avoiding a coin stuck problem.

2. Description of the Related Art

A coin hopper is designed for use in a coin exchange machine, gambling machine, amusement machine or vending machine for sending out or issuing coins or tokens one by one. However, coins or token having different thicknesses, sizes and/or shapes may be used in different countries or different machines.

A conventional coin hopper is known using a motor to rotate a rotating disc for dispensing coins/tokens. The rotating disc has a plurality of equiangularly spaced pins. A guide member and a micro switch are respectively mounted in the inner side and outer side of the coin outlet of the coin hopper. During rotation of the rotating disc, coins/tokens are pushed one by one by the pins of the rotating disc toward the coin outlet and then guided out of the coin outlet by the guide member. In order to ensure operation stability, a lever is provided between the rotating disk and the coin outlet for pushing a stacked coin away, avoiding a coin stuck problem.

FIG. 10 illustrates a coin hopper according to the prior art design. As illustrated, the coin hopper comprises a hopper body A, a rotating disk A1 rotatably mounted in the hopper body A and defining a plurality of coin grooves A11, an axle A2 and a stop member A3 disposed near the periphery of the rotating disk A1, and a coin-dispensing mechanism B. The coin-dispensing mechanism B comprises a spring member B2, and a lever B1 that has one end thereof pivotally coupled to the axle A2 and a bearing portion B11 located on an opposite end thereof and pressed on the stop member A3. When a motor (not shown) is started to rotate the rotating disk A1, coins C are forced by a centrifugal force to move out of the coin grooves A11 of the rotating disk A1 toward the lever B1.When one coin C is moving out of one coin groove A11, it will give a pressure to the lever B1 to compress the spring member B2. As soon as the coin C moved out of the respective coin groove A11, the spring member B2 immediately returns to its former shape to return the lever B1 to its former position, avoiding delivery of multiple coins C to the coin outlet at a time.

According to the aforesaid prior art design, the lever B1 is pivotally coupled to the axle A2 and supported on the spring member B2. However, when dispensing coins C having different sizes, these coins C will give different pressure to the lever B1 against the spring member B2, causing stress concentration. Thus, the spring member B2 will wear and fail quickly. Further, it is difficult to control the gap between the lever B1 and the coin groove A11 of the rotating disk A1 subject to the thickness of the coin C being delivered. When dispensing coins C, coins C may be delivered in a stack, causing a coin stuck problem.

Therefore, it is desirable to provide a coin hopper that eliminates the aforesaid problem.

### SUMMARY OF THE INVENTION

The present invention has been accomplished under the circumstances in view. It is therefore the main object of the present invention to provide a coin hopper, which is practical for dispensing coins/tokens having different thicknesses, preventing a coin stuck problem.

To achieve this and other objects of the present invention, a coin hopper of the invention comprises a coin-dispensing unit and a coin-delivering presser. The coin-dispensing unit comprises a hopper defining a coin outlet, a rotating disk rotatably mounted in the hopper, a circuit module, a power drive controlled by the circuit module to rotate the rotating disk, and a sensor module controlled by the circuit module to detect the value and authenticity of coins having different thicknesses. The coin-delivering presser is mounted in the hopper, comprising an elastic member and a float rotatably supported on the elastic member for pressing on one coin in the rotating disk, enabling coins to be individually and smoothly delivered to the coin outlet for dispensing during rotation of the rotating disk and avoiding a coin stuck problem.

Further, because the float is supported on the elastic member, the gap between the float and the rotating disk is automatically adjustable for allowing delivery of one individual thick coin or thin coin therethrough. As the float is supported on the elastic member when it is pressed on one coin being delivered, the friction force thus produced between the float and the coin is sufficient to move the coin toward the coin outlet without causing damage. Further, due to spot contact between the float and the coin, the friction force thus produced between the float and the coin is small, avoiding an overpressure. Thus, the elastic member will not wear quickly with use.

### BRIEF DESCRIPTION OF THE DRAWINGS

FIG. 1 is an oblique top elevational view of a coin hopper in accordance with the present invention.

FIG. 2 is an exploded view of the coin hopper in accordance with the present invention.

FIG. 3 corresponds to FIG. 2 when viewed from another angle.

FIG. 4 is an enlarged view of a part of FIG. 2, illustrating the structure of the coin pusher of the coin hopper.

FIG. 5 corresponds to FIG. 4 when viewed from another angle.

FIG. 6 is a schematic sectional view of the coin hopper in accordance with the present invention.

FIG. 7 is an enlarged view of part A of FIG. 6, illustrating the float pressed on a thick coin.

FIG. 8 is similar to FIG. 7, illustrating one thin coin entered the gap between the float and the rotating disk.

FIG. 9 is similar to FIG. 7, illustrating one thin coin entered the gap between the float and the rotating disk and another thin coin stopped at the float.

FIG. 10 is a schematic drawing of a part of a coin hopper according to the prior art.

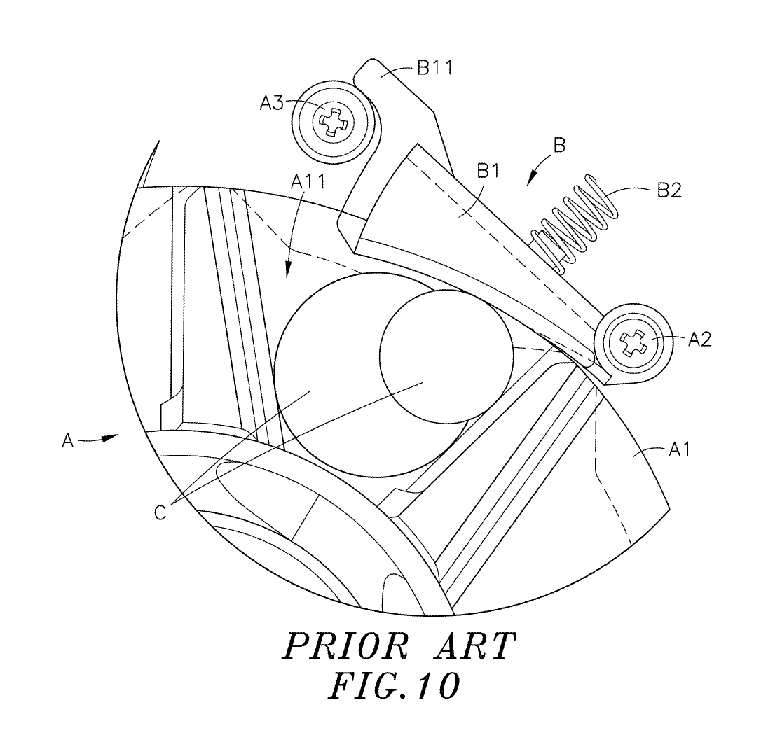

### DETAILED DESCRIPTION OF THE PREFERRED EMBODIMENT

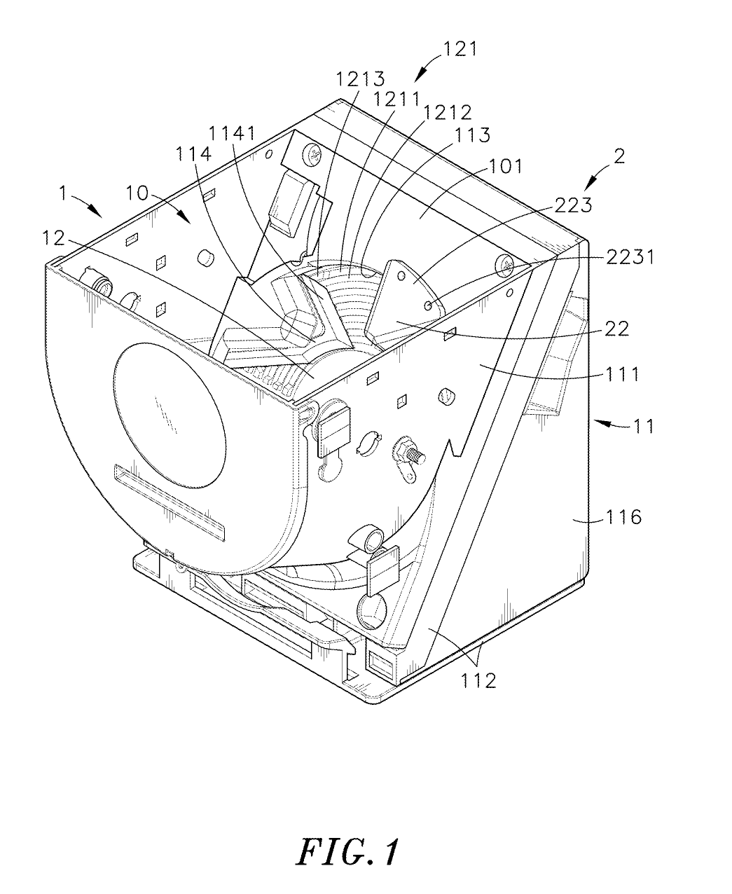

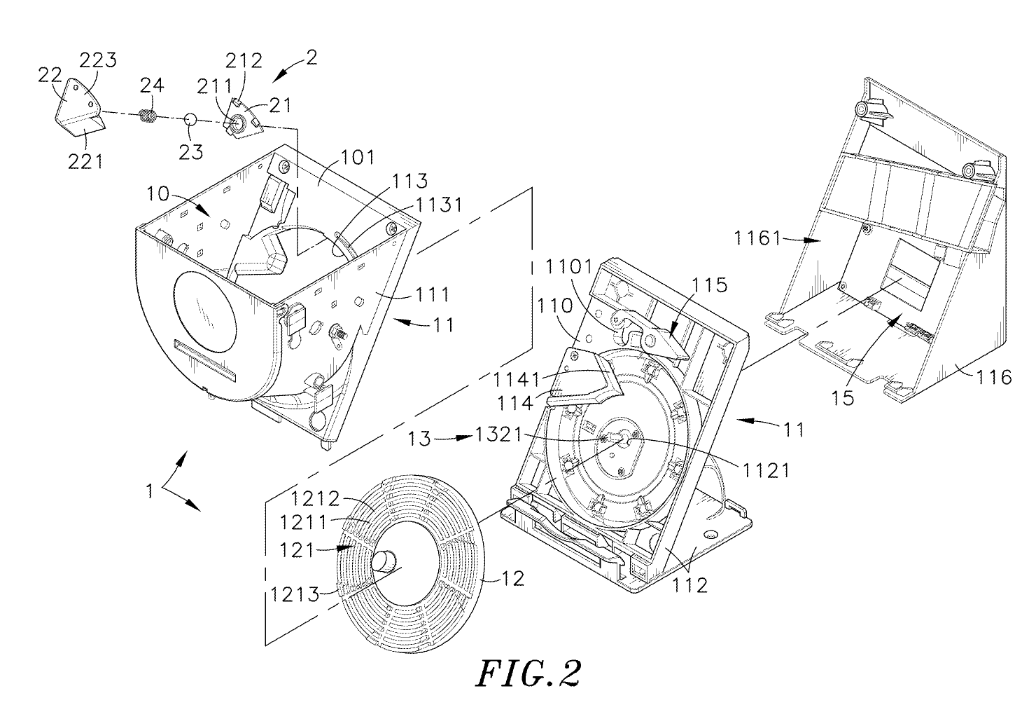

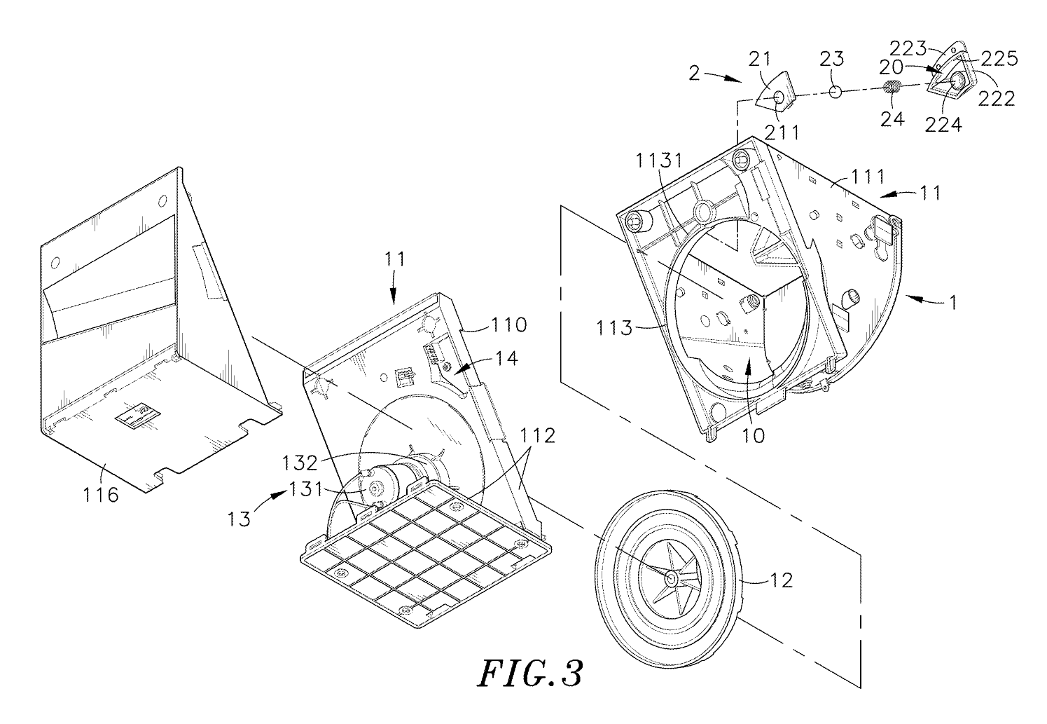

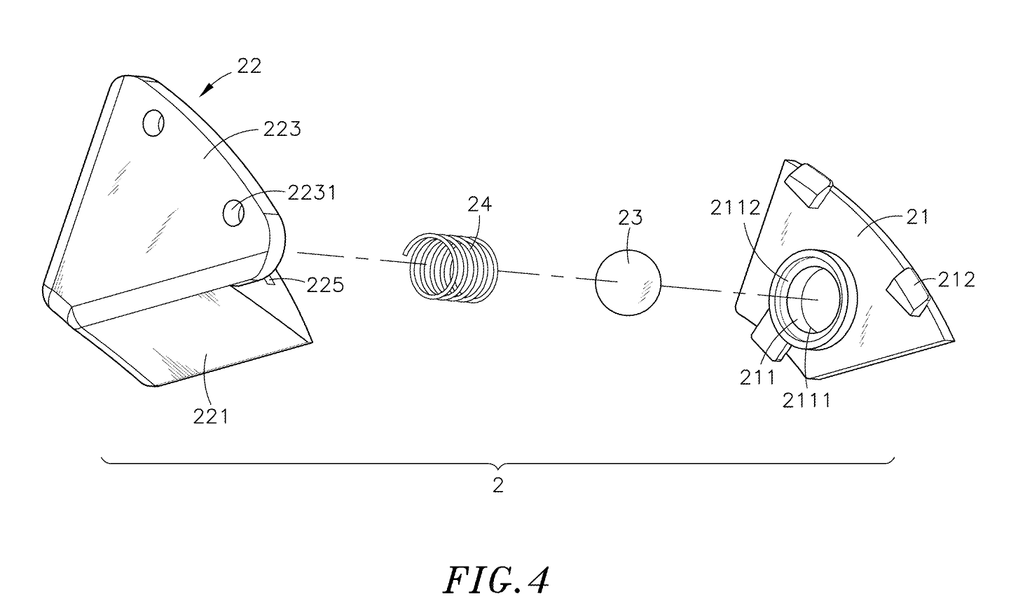

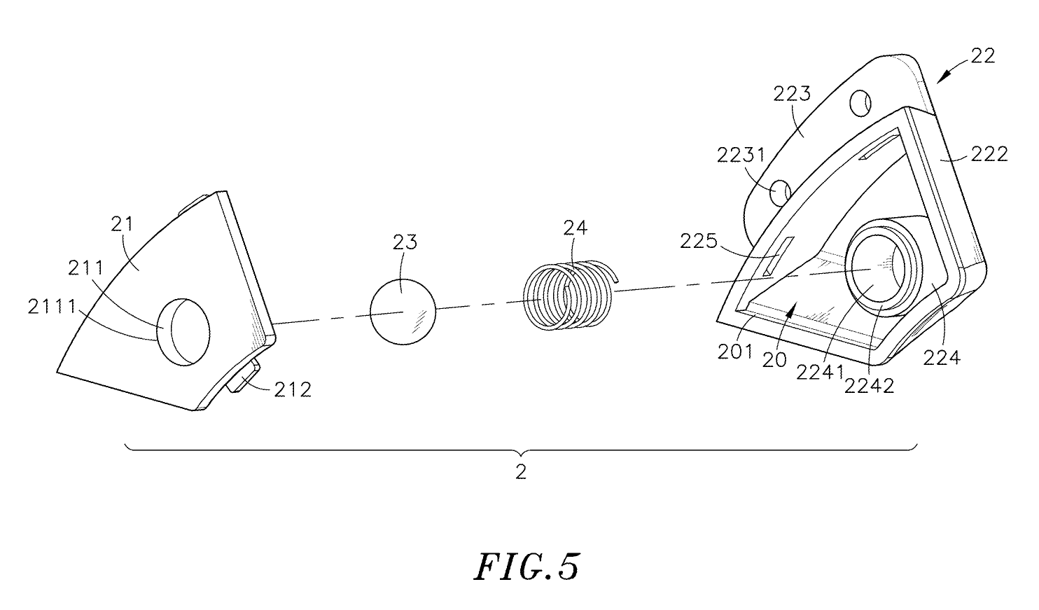

Referring to FIGS. 1-5, a coin hopper for use in a coin dispenser in accordance with the present invention is shown. The coin hopper comprises a coin-dispensing unit 1 and a coin-delivering presser 2.

The coin-dispensing unit 1 comprises a hopper 11 comprising a hopper body 111 and a support base 112, a rotating disk 12, and a power drive 13. The support base 112 defines a through hole 1121 at a selected location. The hopper body 111 defines an accommodation chamber 10, a top opening 101 disposed at a top side thereof in communication with the accommodation chamber 10 and the atmosphere, and a back opening 113 disposed in a back side thereof in communication with the accommodation chamber 10 and the atmosphere. The rotating disk 12 is rotatably supported on a front side of the support base 112 of the hopper 11 and rotatably positioned in the back opening 113 of the hopper body 111. The power drive 13 comprises a motor 131 mounted in a back side of the support base 112 of the hopper 11, and a transmission mechanism 132 mounted in the back side of the support base 112 of the hopper 11 and coupled to the motor 131. The transmission mechanism 132 comprises an output shaft 1321 inserted through the through hole 1121 of the support base 112 and coupled to the rotating disk 12. Thus, the motor 131 can be driven to rotate the transmission mechanism 132 and the rotating disk 12 relative to the hopper 11.

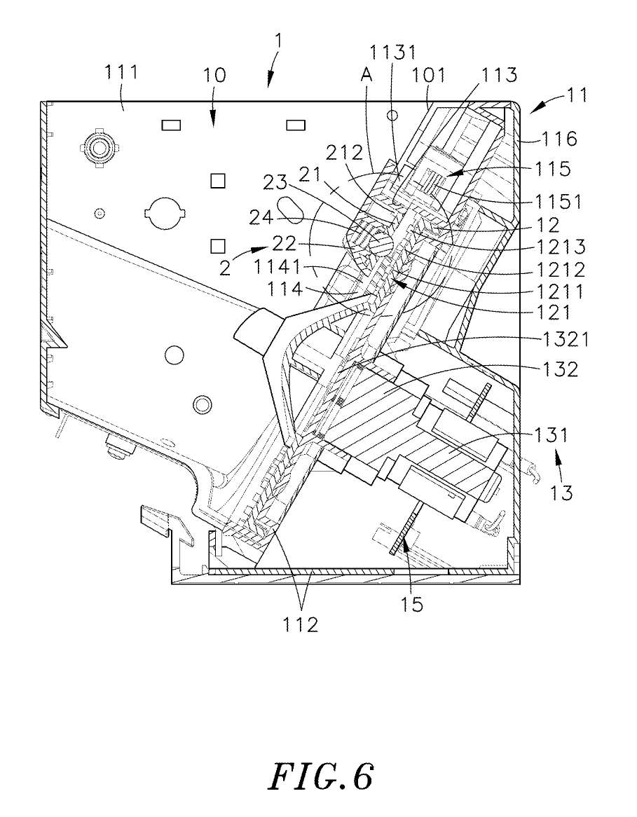

The hopper 11 of the coin-dispensing unit 1 further comprises a coin outlet 110 defined between the hopper body 111 and the support base 112 and disposed in communication between the inside space of the support base 112 and the atmosphere and facing toward the circumference of the rotating disk 12, a stopper member 114 located on the front side of the support base 112 below the coin outlet 110, a coin ejection mechanism 115 pivotally mounted at the front side of the support base 112 above the coin outlet 110 and disposed opposite to the stopper member 114 and comprising a torsion spring 1151 (see FIG. 6), and a back cover 116 covered on the back side of the support base 112. The back cover 116 defines therein a receiving chamber 1161. The coin-dispensing unit 1 further comprises a sensor module 14 mounted in the support base 112 corresponding to the coin outlet 110, and a circuit module 15 mounted in the receiving chamber 1161 within the back cover 116 and electrically connected with the power drive 13 and the sensor module 14.

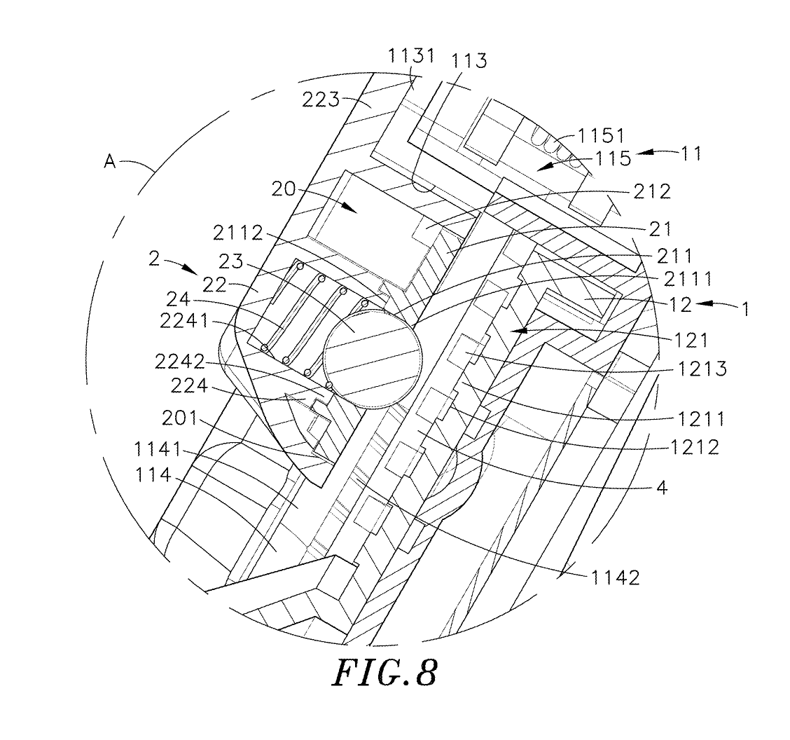

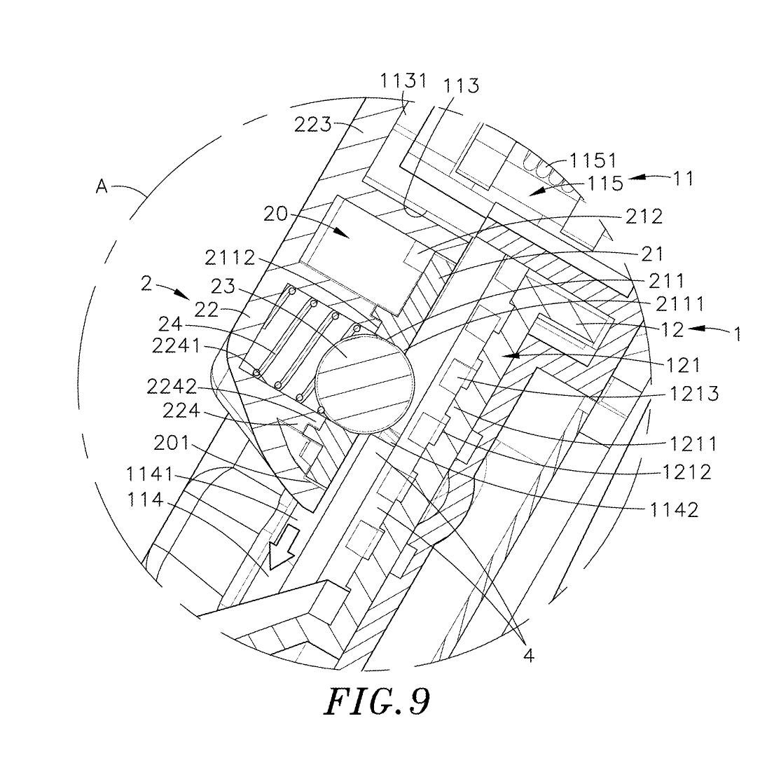

The support base 112 of the hopper 11 of the coin-dispensing unit 1 defines a recessed portion 1101 corresponding to the coin outlet 110 for receiving one end of the coin ejection mechanism 115 and guiding pivot motion of the coin ejection mechanism 115. The hopper body 111 of the hopper 11 of the coin-dispensing unit 1 comprises a smoothly arched mounting slot 1131 extending along an upper part of the back opening 113. Further, the rotating disk 12 comprises a plurality of coin-pushing units 121 located on a front side thereof and arranged around a circle. Each coin-pushing unit 121 comprises a plurality of smoothly arched ribs 1211 equally spaced from one another in direction away from the center of the rotating disk 12 in a parallel manner, a smoothly arched groove 1212 defined between each two adjacent smoothly arched ribs 1211, and a push block 1213 located at one end of each smoothly arched rib 1211. Further, the stopper member 114 comprises a beveled guide face 1141 sloping downwardly outwardly from a top side thereof, and a plurality of stop blocks 1142 located on a back side thereof and respectively inserted into the smoothly arched grooves 1212 of one coin-pushing unit 121 of the rotating disk 12 (see FIGS. 8 and 9).

The coin-delivering presser 2 comprises a base member 21, a cover member 22, a float 23 and an elastic member 24. The base member 21 comprises an accommodation hole 211 for accommodating the float 23, a stop flange 2111 extending around one end of the accommodation hole 211 for stopping the float 23 in the accommodation hole 211, a locating groove 2112 extending around an opposite end of the accommodation hole 211, and a plurality of hook blocks 212 spaced around the border thereof.

The cover member 22 of the coin-delivering presser 2 is capped on the base member 21 and fastened to the base member 21 by, for example, a hook joint. Alternatively, the cover member 22 and the base member 21 can be fastened together with screws or high-frequency heat sealing. The cover member 22 comprises a receiving chamber 20 for accommodating the float 23 and the elastic member 24, comprising a first bevel wall 221 and a second bevel wall 222 disposed at two opposite lateral sides thereof and defining therebetween an acute angle, a mounting flange 223 backwardly extended from a rear side thereof, and a plurality of mounting through holes 2231 cut through the mounting flange 223.

The cover member 22 further comprises an inside tube 224 suspending in the receiving chamber 20 and facing toward the base member 21, a plurality of hook holes 225 spaced around the periphery thereof adjacent to the outer open side 201 of the receiving chamber 20 and respectively forced into engagement with the hook blocks 212 of the base member 21. The inside tube 224 comprises an axially extending tube hole 2241 and an annular locating flange 2242 located at a distal end thereof around the axial extending tube hole 2241 and positioned in the locating groove 2112 of the base member 21. Further, the float 23 in this embodiment is a rolling ball. In actual application, the float 23 can be a rolling cylinder or elliptical cylinder. Further, the elastic member 24 can be, for example, a compression spring, having its one end inserted into the axially extending tube hole 2241 of the inside tube 224 and its other end stopped against the float 23.

When assembling the coin hopper, the coin-delivering presser 2 is fastened to the hopper body 111 of the hopper 11 of the coin-dispensing unit 1 adjacent to the coin outlet 110 between the hopper body 111 and the support base 112 by: attaching the mounting flange 223 of the cover member 22 of the coin-delivering presser 2 to the inside wall of the hopper body 111 adjacent to the back opening 113 to aim the mounting through holes 2231 of the cover member 22 at the smoothly arched mounting slot 1131 of the hopper body 111 and then inserting respective screw bolts (not shown) through the mounting through holes 2231 of the cover member 22 at the smoothly arched mounting slot 1131 and fastening respective screw nuts (not shown) to the respective screw bolts to affix the mounting flange 223 of the cover member 22 to the hopper body 111. Further, the user can loosen the screw nuts and then move the coin-delivering presser 2 along the smoothly arched mounting slot 1131 to adjust the position of the coin-delivering presser 2 relative to the coin outlet 110 of the hopper 11, and then fasten up the screw nuts after adjustment of the position of the coin-delivering presser 2. After installation of the coin-delivering presser 2 in the hopper 11 of the coin-dispensing unit 1, the float 23 is aimed at the rotating disk 12 and kept apart the rotating disk 12 at a predetermined distance.

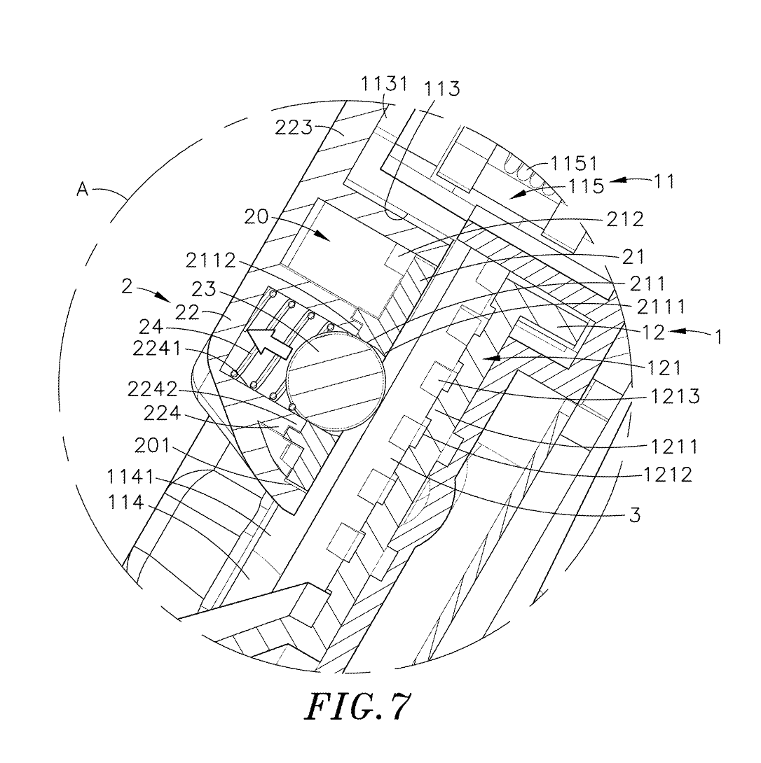

Referring to FIGS. 6-9, the coin hopper can be used independently. Alternatively, the coin hopper can be used in an automatic vending machine, a game machine, or any consumer system for selling consumer services. After installation of the coin hopper in a main unit of an automatic vending machine, game machine or consumer system, the circuit module 15 is electrically connected to the main unit by a transmission line. During operation, the circuit module 15 controls the operation of the power drive 13 to rotate the rotating disk 12, and the operation of the sensor module 14 to detect the amount, value and authenticity of coins. As the operation of the power drive 13, the sensor module 14 and the circuit module 15 are of the known art and not within the scope of the claims of the present invention, no further detailed description in this regard will be necessary.

When thick coins 3 and thin coins 4 of different values are inserted through the top opening 101 of the hopper body 111 into the accommodation chamber 10, these coins 3;4 are accumulated in the hopper body 11. After accumulation of a certain amount of coins 3;4, the motor 131 of the power drive 13 is started to rotate the transmission mechanism 132 and the rotating disk 12, causing the thick coins 3 and the thin coins 4 to be pushed by the push blocks 1213 of the coin-pushing units 121 of the rotating disk 12 and supported on the smoothly arched ribs 1211, and then squeezed by the stop blocks 1142 of the stopper member 114 to move along the stop blocks 1142 and the coin ejection mechanism 115 toward the outside of the coin outlet 110. Some other coins 3 or 4 that are squeezed by the stop blocks 1142 of the stopper member 114 are forced to move downwardly along the beveled guide face 1141 to bias the coin ejection mechanism 115, causing the torsion spring 1151 to store elastic potential energy. As soon as squeezing pressure is released from the downwardly moving coins 3 or 4, the torsion spring 1151 immediately forces the coin ejection mechanism 115 to push the coins 3 or 4 out of the coin outlet 110 of the hopper 11.

During rotation of the rotating disk 12 of the coin hopper 1, the push blocks 1213 of the coin-pushing units 121 of the rotating disk 12 push the coins 3;4 to move to the gap between the float 23 of the coin-delivering presser 2 and the rotating disk 12 in proper order, or to move down along the first bevel wall 221 and second bevel wall 222 of the cover member 22. When one thick coin 3 is moved to the float 23, this thick coin 3 pushes the float 23 toward the inside of the accommodation hole 211 of the base member 21 to compress the elastic member 24 due to that the thickness of the thick coin 3 is larger than the distance between the float 23 of the coin-delivering presser 2 and the rotating disk 12, and the float 23 is kept rotating over the thick coin 3 during continuous rotation of the rotating disk 12, enabling the thick coin 3 to be carried to the sensor module 14 adjacent to the coin outlet 110 where the sensor module 14 detect the value and authenticity of the thick coin 3. As the float 23 is supported on the elastic member 24 and rotatably stopped against a small part of the thick coin 3, the friction force thus produced between the float 23 and the thick coin 3 is small but sufficient to move the thick coin 3 to the sensor module 14 for recognition.

Further, the distance between the float 23 of the coin-delivering presser 2 and the rotating disk 12 is larger than the thickness of thin coins 4. If one thin coin 4 is carried by the rotating disk 12 of the coin hopper 1 to the gap between the float 23 of the coin-delivering presser 2 and the rotating disk 12, this thin coin 4 can enter the gap between the float 23 of the coin-delivering presser 2 and the rotating disk 12 directly without pushing the float 23 backwards. However, if the rotating disk 12 of the coin hopper 1 carries two stacked thin coins 4 to the coin-delivering presser 2 at the same time, the combined thickness of these two stacked thin coins 4 is larger than the gap between the float 23 of the coin-delivering presser 2 and the rotating disk 12, one of these two stacked thin coins 4 will be peripherally stopped against the float 23 and forced by the float 23 to fall down from the respective coin-pushing unit 121, allowing the other thin coin 4 to be carried to the sensor module 14 for recognition and further dispensing and, avoiding stuck coins.

In conclusion, the invention provides a coin hopper, which comprises a coin-dispensing unit 1 comprising a hopper 11, a rotating disk 12, a power drive 13, a sensor module 14 and a circuit module 15 for dispensing coins 3;4 having different thicknesses, and a coin-delivering presser 2 mounted in the hopper 11 and comprising an elastic member 24 and a float 24 rotatably supported on the elastic member 24 for pressing the coins 3;4 in the rotating disk 12, enabling the coins 3;4 to be individually and smoothly delivered to a coin outlet 110.

It is to be understood that the above-described embodiment of the invention is merely a possible example of implementations, merely set forth for a clear understanding of the principles of the invention, many modifications and enhancements may be made without departing from the spirit and scope of the invention. Accordingly, the invention is not to be limited except as by the appended claims.

What the invention claimed is:

1. A coin hopper for dispensing coins, comprising:
a coin-dispensing unit comprising a hopper, said hopper comprising a hopper body and a coin outlet, said hopper body defining therein an accommodation chamber for holding predetermined thick coins and thin coins, a rotating disk rotatably mounted in said hopper adjacent to said coin outlet, and a power drive adapted for rotating said rotating disk to deliver said thick coins and said thin coins to said coin outlet; and
a coin-delivering presser mounted in said hopper body of said hopper adjacent to said coin outlet, said coin-delivering presser comprising a base member, a cover member covered on said base member, said base member defining therein a receiving chamber and an accommodation hole in communication with said receiving chamber and the atmosphere and facing toward said rotating disk, an elastic member mounted in said receiving chamber and a float supported on said elastic member and partially projecting out of said accommodation hole for pressing on one individual said thick coin or said thin coin in said rotating disk, said float being movable in and out of said accommodation hole between an extended position and a received position to adjust the gap between said base member and said rotating disk for enabling said thick coins and said thin coins to pass through the gap between said base member and said rotating disk individually.

2. The coin hopper as claimed in claim 1, wherein said hopper body comprises a back opening disposed in communication with said accommodation chamber; said hopper further comprises a support base supporting said hopper body; said rotating disk is rotatably supported on said support base in said back opening of said hopper body; said power drive comprises a motor mounted in a back side of said support base of said hopper, and a transmission mechanism mounted in the back side of said support base of said hopper and coupled to said motor, said transmission mechanism comprising an output shaft extending through said support base and coupled to said rotating disk and rotatably by said motor to rotate said rotating disk relative to said hopper.

3. The coin hopper as claimed in claim 2, wherein said coin outlet is defined between said hopper body and said support base.

4. The coin hopper as claimed in claim 2, wherein said hopper further comprises a back cover covered on the back side of said support base and defining therein a receiving chamber; said coin-delivering presser further comprises a sensor module mounted in said support base of said hopper adjacent to said coin outlet, and a circuit module mounted in the receiving chamber inside said back cover of said hopper and electrically connected with said power drive and said sensor module for controlling said power drive to rotate said rotating disk and said sensor module to detect the value and authenticity of said thick coins and said thin coins.

5. The coin hopper as claimed in claim 2, wherein said hopper body further comprises a smoothly arched mounting slot extending along an upper part of said back opening; said cover member of said coin-delivering presser comprises a first bevel wall and a second bevel wall disposed at two opposite lateral sides thereof and defining therebetween an acute angle, and mounting flange backwardly extended from a rear side thereof and adjustably fastened to said smoothly arched mounting slot of said hopper body with screw bolts and nuts.

6. The coin hopper as claimed in claim 1, wherein said hopper further comprises a stopper member disposed at a bottom side relative to said coin outlet, said stopper member comprising a beveled guide face sloping downwardly outwardly from a top side thereof toward said rotating disk, and a spring-loaded coin ejection mechanism pivotally disposed at a top side relative to said coin outlet and opposite to said stopper member for ejecting said thick coins and said thin coins out of said coin outlet.

7. The coin hopper as claimed in claim 6, wherein said rotating disk comprises coin-pushing units located on a front side thereof and arranged around a circle, each said coin-pushing unit comprising a plurality of smoothly arched ribs equally spaced from one another in direction away from the center of said rotating disk in a parallel manner, a smoothly arched groove defined between each two adjacent said smoothly arched ribs, and a push block located at one end of each said smoothly arched rib; said stopper member of said hopper further comprises a plurality of stop blocks located on a back side thereof and respectively inserted into the smoothly arched grooves of one said coin-pushing unit of said rotating disk.

8. The coin hopper as claimed in claim 6, wherein said hopper further comprises a recessed portion corresponding to said coin outlet and adapted for receiving one end of said spring-loaded coin ejection mechanism and guiding pivot motion of said spring-loaded coin ejection mechanism.

9. The coin hopper as claimed in claim 1, wherein said base member of said coin-delivering presser further comprises a stop flange extending around one end of said accommodation hole for stopping said float in said accommodation hole, and a locating groove extending around an opposite end of said accommodation hole; said cover member of said coin-delivering presser further comprises an inside tube facing toward said base member, said inside tube comprising an axially extending tube hole and an annular locating flange located at a distal end thereof around said axial extending tube hole and positioned in said locating groove of said base member; said elastic member has one end thereof inserted into said axially extending tube hole of said inside tube and an opposite end thereof stopped against said float.

10. The coin hopper as claimed in claim 1, wherein said base member of said coin-delivering presser further comprises a plurality of hook blocks spaced around the border thereof; said cover member of said coin-delivering presser further comprises a plurality of hook holes spaced around the periphery thereof and respectively engaged with said hook blocks of said base member.
